(19) United States
(12) Patent Application Publication
(10) Pub. No.: US 2003/0144895 A1
(43) Pub. Date: Jul. 31, 2003

(54) Prepaid personal advisory service for cellular networks

(75) Inventors: Arda Aksu, Watertown, MA (US); Haiping Luo, Malden, MA (US); Seshadri Mohan, Basking Ridge, NJ (US)

Correspondence Address: STAAS & HALSEY LLP, 700 11TH STREET, NW, SUITE 500, WASHINGTON, DC, 20001, US

(73) Assignee: Comverse, Inc., Wakefield, MA (US)

(21) Appl. No.: 10/058,424

(22) Filed: Jan. 30, 2002

(51) Int. Cl. G06F 17/60

(52) U.S. Cl. 705/9

(57) ABSTRACT

A real-time personal advisory service. In a preferred embodiment, experts access a server and register, providing their credentials, charge rates, and keywords related to their field of expertise. Information regarding the experts and customers are stored in a database. A registered customer sends a question as an SMS message to the server through a cellular device. The server scans the question for keywords and uses the keywords to query the database, generating a list of experts likely to be willing to answer the question. The question is then forwarded as another SMS message to the experts. Experts wanting to answer the question press an accept button, sending an SMS message back to the server. The server sends an SMS message to the customer, indicating that there are experts who want to answer the question. The customer selects an expert and replies to the message. The server then bridges the parties.

### BACKGROUND OF THE INVENTION

1. Field of the Invention

The present invention is directed to a real-time personal advisory service, and, more particularly, to a system for parsing a customer's question for keywords and matching the keywords to expert-generated keywords to identify registered experts likely to be willing to answer the question, sending the question to the experts, informing the customer of experts who have indicated a willingness to answer the question, and bridging the customer and the expert selected by the customer.

2. Description of the Related Art

People need timely, accurate, relevant, and useful information on a wide-ranging set of topics impacting their quality of life, from computer repairs to tax issues to dieting. Internet searches for information sometimes provide useful answers, but are very inefficient. It takes a lot of time to sort through the information presented by the Internet search. Often, a technical background is required to perform a meaningful search. Moreover, devices such as laptops and personal computers (PCs) with Internet access are required.

The Internet also enables people to exchange ideas, and forums provide the ability to search for a particular topic and even post a question. However, this also requires time to do the search to find the appropriate mailing list, if one exists, post the question, and wait an undetermined amount of time to receive a response. Often, questions are left unanswered using this approach.

Advice from an available expert on specific questions and topics is much more useful than time-consuming searches for information. However, for an Internet-based approach where a search is used to find an expert, if the user uses a modem to connect to the Internet and finds an expert to call, the user must drop the connection first to make a phone call to the expert. Also, if the user sends an e-mail message to the expert, again, the user must wait an undetermined amount of time to receive a reply. A reply may be received in a matter of minutes, hours, days, or a reply may never be received.

In a more narrow sense, call centers or customer support centers may also provide answers to some specific questions related to a particular product. However, the question topics are limited, and often it is difficult to find the right number to call or to speak to a person rather than to an automated answering system. Also, call centers or customer support centers are usually quite costly. Often these types of services are more frustrating than useful to the user.

A way is needed for users, using only one device such as a mobile phone, to get their questions answered quickly and efficiently, without the need to perform an Internet search before placing a call for help or advice.

### SUMMARY OF THE INVENTION

It is an aspect of the present invention to provide a real-time system and method of locating and matching experts to customers needing advice.

It is another aspect of the present invention to provide a system and method of communicating with the customers and the experts using short messaging service (SMS) messages.

It is a further aspect of the present invention to provide a system and method for the self-declared experts to register their credentials and keywords related to their fields of expertise.

It is a still further aspect of the present invention to match the keywords provided by the experts with keywords extracted from the text of a customer's question to find experts qualified to answer the customer's question.

It is a further aspect for the present invention to match keywords provided by the experts with keywords extracted from the customer's spoken question to find experts qualified to answer the customer's question.

It is a further aspect of the present invention to forward the customer's question to the experts qualified to answer the question without identifying the customer.

It is a further aspect of the present invention to provide a list of qualified experts to the customer from which the customer selects an expert to answer the customer's question.

It is a further aspect of the present invention to establish a telephone connection between the customer and the selected expert.

It is a further aspect of the present invention to allow the customers to rate the experts after the experts have provided their services.

It is a further aspect of the present invention to provide a prepaid billing system for charging accounts of the customers and experts.

The present invention attains the above aspects by providing, in a preferred embodiment, a prepaid personal advisory (PPA) service for cellular or Personal Communication Service (PCS) networks, which provides a complete, convenient resource for live and immediate advice on a topic selected by a customer. Experts register their credentials and field of expertise with a registrar database. The present invention enables customers to pose questions to experts without needing to know the identity of the experts, and brings together the experts and the customers needing advice. Short messaging service (SMS) is used for posing the question and finding the expert, and voice calls are placed to bridge the customer and the expert.

In the preferred embodiment, experts and customers first access a PPA server to register. The experts provide their credentials, charge rates, and keywords related to their field or fields of expertise. Information regarding the experts and customers are stored in a PPA database. A registered customer sends a question as an SMS message to the PPA server through a cellular or PCS device. The PPA server scans the question for keywords and uses the keywords to query the PPA database to generate a list of experts likely to be willing to answer the question. The question is then forwarded as another SMS message to the experts with customer-related information removed. If an expert wishes to answer the question, he or she presses an accept button, sending an SMS message back to the PPA server. The PPA server sends an SMS message to the customer, indicating that there is an expert or experts who want to answer the question and informing the customer of the charge rates. The customer selects an expert and replies to the message. The PPA server places a call to the expert and to the customer and then bridges the two parties. Thus, the present invention provides the ability for a customer to receive help from a self-registered expert in real-time (i.e., within a matter of minutes rather than hours or days), reducing the work of the customer by automatically providing the best match of experts.

These, together with other aspects and advantages that will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a schematic diagram of the functional architecture of a system according to the present invention;

FIG. 2 is a schematic diagram of the registration process for the system of FIG. 1;

FIGS. 3A and 3B are flow diagrams of prepaid personal advisory server 6 processing according to the present invention;

FIG. 4 is a schematic diagram of a short messaging service message according to the present invention; and

FIG. 5 is a call flow diagram of the flow of data during operation of a preferred embodiment of the present invention.

### DESCRIPTION OF THE PREFERRED EMBODIMENTS

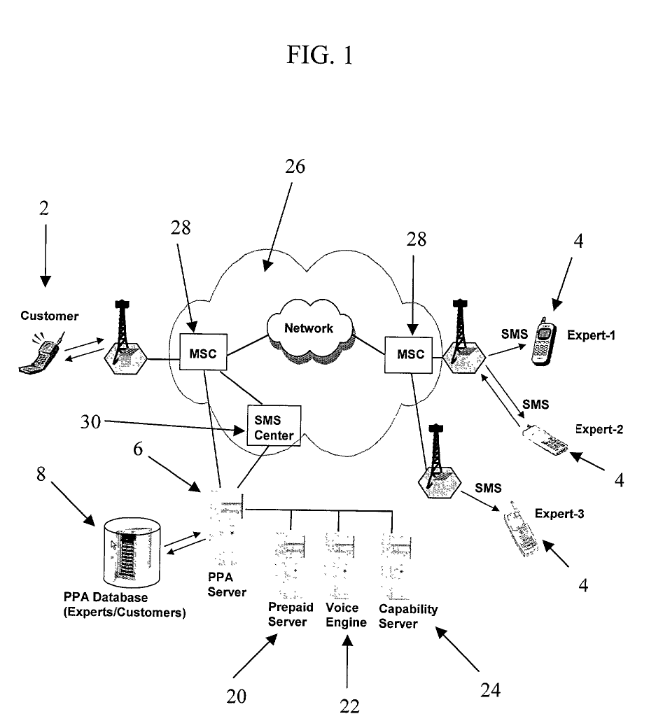

A preferred embodiment of the present invention is generally illustrated in FIG. 1. In the preferred embodiment, a customer 2 uses a wireless phone to send a question in the form of a short messaging service (SMS) message, through a cellular network 26 of mobile switching centers (MSC) 28, to a prepaid personal advisory (PPA) server 6. An SMS center 30 stores and forwards the short messages in the cellular network 26. A Personal Communications Service (PCS) network may also be used. The PPA server 6 processes the message from the customer 2 using information stored in a PPA database 8 to determine what experts 4 may be interested in responding to the question. After processing the message, the PPA server 6 sends the customer's question in the form of an SMS message to one or more of the experts 4. The experts 4 who want to respond to the question send an SMS reply to the PPA server 6, which then informs the customer 2 of those experts 4 who responded to the customer's question.

A voice engine 22 and a capability server 24 are provided in the preferred embodiment to handle voice messages and wireless phones that are not SMS enabled. The voice engine 22 and the capability server 24 are described in greater detail below. If SMS is used exclusively, the voice engine 22 and the capability server 24 may be omitted. In addition, if prepaid billing is not used, then the prepaid server 20 may be omitted.

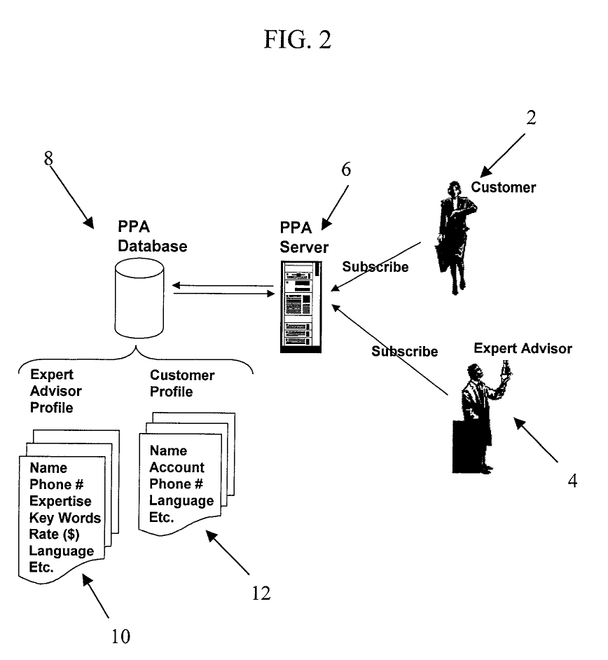

The customers 2 and experts 4 register with the service provider before using the PPA service. Registrations are needed for contact and billing information. FIG. 2 depicts the registration process. Potential customers and experts register by accessing the service provider's web site, using a computer or wireless application protocol (WAP) phone, and filling in a form that completes corresponding profiles 10 and 12. Alternatively, a customer or expert may place a telephone call to the service provider and register by speaking to a representative or responding to an automated attendant.

Table 1 below provides examples of the information collected during registration to create an expert advisor profile 10 and a customer profile 12. The expert advisor profile 10 and the customer profile 12 are stored in the PPA database 8. Additional information collected may include a password, the names of the customer 2 and the expert 4, and the phone number of an SMS-enabled mobile phone for contact information. Also, the customers 2 and experts 4 indicate a preferred language to use to access the PPA server 6. The experts 4 also provide a charge rate, such as the amount charged per call or per minute.

TABLE 1
Customer and Expert Advisor Profile Fields for PPA Service

| Customer Profile: | Expert Advisor Profile: |
|---|---|
| Name | Name |
| Account No. | Account No. |
| Phone No. | Phone No. |
| Address | Address |
| Preferred language | Language (s) |
| | Expertise Area |
| | Key Words |
| | Charge Rate ($/min) |

The experts 4 are self-declared expert advisors. Thus, during registration, the experts 4 provide a brief description of their area of expertise, and keywords for the PPA server 6 to use when querying the PPA database 8 to match a customer 2 with one or more experts 4. The experts 4 may rate themselves by, for example, providing a number from 1 to 10 (i.e., from very experienced to less experience). Alternatively, the customers 2 may rate the experts 4 by providing feedback to the PPA server 6, or through third-party certification.

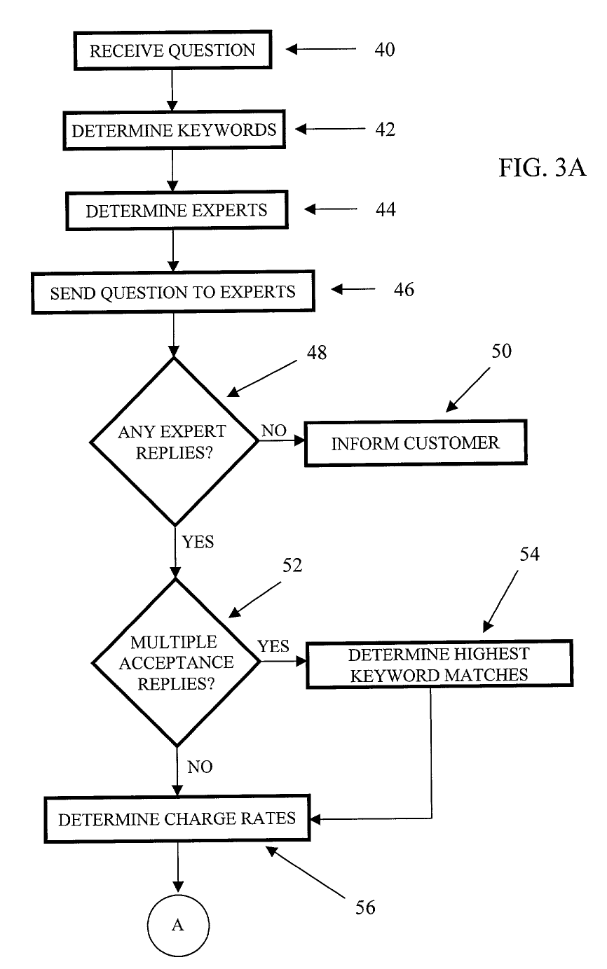

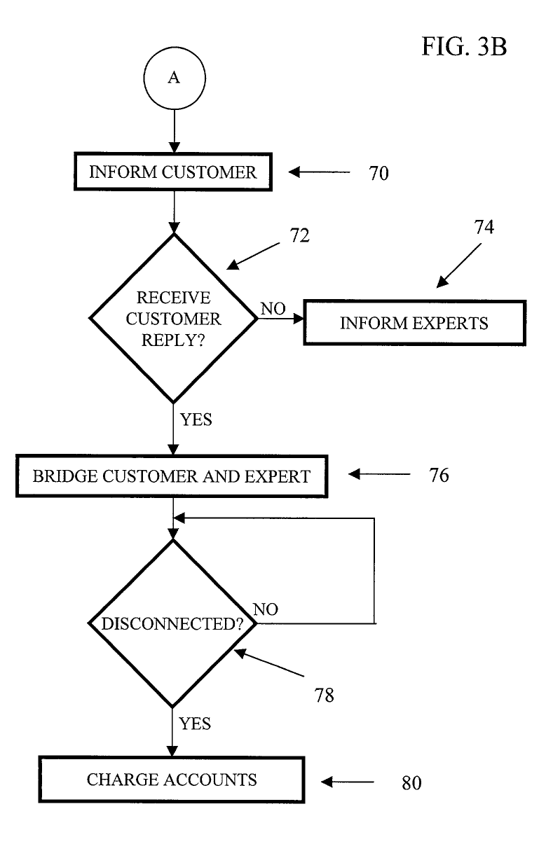

FIGS. 3A and 3B are flow diagrams of PPA server 6 processing. In FIG. 3A, the PPA server 6 receives 40 a question from a registered customer 2 as an SMS message. The question is a “free format” question because the question will be sent to the experts 4 exactly as written by the customer 2. The SMS message contains additional information, such as the customer's name and a unique identification number, for recognition and billing purposes. An example of a question may be the following: “How do I install MS-Word on my iPAQ?”.

The PPA server 6 performs 42 conventional text indexing on the received SMS message to find the keywords to query the PPA database 8. For the sample question above, the keywords might be “iPAQ”, “install,” and “MS-Word.” Examples of text-indexing products that can be used for this operation include Time Matters® Software Version 4.0 by DATA.TXT Corp. of Miami, Fla.; The TDOC System by TDOC Projects Ltd.; ProCAT® by Advanced Translations Technology, Inc., of Woodland Hills, Calif.; and ProIndex by InfoSphere, Inc. of South Jordan, Utah.

The PPA server 6 performs keyword matching using the expert advisor profile 10 in the PPA database 8 to determine 44 the experts 4 who might be knowledgeable in the field posed by the question. Based on a matching criteria, such as, preferably, the percentage of the keywords matched, the PPA server 6 prepares a list of likely experts 4 who might be willing to answer the question. The PPA server 6 strips information that would identify the customer 2 to the expert 4 from the SMS message (e.g., name and phone number) and, depending upon the capabilities of the recipient's phone, conventionally adds an “accept” button to the message. Then, the PPA server 6 forwards 46 the question to the experts 4 determined during keyword matching, using SMS messaging, exactly as the customer 2 phrased the question.

The experts 4 who read the question and decide to accept the request for advice select the “accept” button or the reply button of their phones. Selecting the “accept button” sends an SMS message back to the PPA server 6, informing the PPA server 6 of the expert's willingness to answer the question. If no experts 4 have responded 48 within a predetermined amount of time, the PPA server 6 notifies 50 the customer 2 using, for example, SMS messaging or a voice telephone call, that no experts 4 have responded to the customer's question.

If the PPA server 6 receives 52 more than one response from the experts 4, the PPA server 6 determines 54 which expert 4 has the highest number of keyword matches. The PPA server 6 obtains 56 this expert's charge rate from the expert advisor profile 10 of the PPA database 8. The experts 4 may also provide their charge rates in their acceptance response as part of the returned SMS message. For example, if the question is particularly difficult or time-consuming, then an expert 4 may choose to charge a different rate than the rate in his or her expert advisor profile 10. Also, the expert 4 may charge different rates depending on his or her competency in a particular field. The server sends 70 an SMS message back to the customer 2 indicating that there is an expert 4 who wants to answer the question, and informing the customer 2 of the charge rate. Additional information provided to the customer 2 in the SMS message may include the expert's qualifications and ratings.

Alternatively, the PPA server 6 may send a list of all or a predetermined number of responding experts 4 to the customer 2 and allow the customer 2 to select an expert 4. The list may be determined, for example, according to the number of keyword matches or the competency ratings provided by the experts 4 during registration.

Also, the PPA server 6 may forward to the customer 2 the expert or experts having the highest percentage of customer satisfaction. This requires a mechanism for the customers to be able to rate the experts based on the service rendered. For example, at the end of the conversation, the PPA server 6 may call the customer 2 and ask for feedback on the service just received, or the customer 2 may fill out a form rating the service. The PPA server 6 would determine the customer satisfaction percentage and incorporate this information into the PPA database 8.

The customer 2 selects an expert 4 and sends an SMS message back to the PPA server 6. If the PPA server 6 does not receive 72 a reply from the customer 2 within a predetermined amount of time, the PPA server 6 informs 74 the experts 4 who want to answer the question that the customer 2 has not responded.

After the PPA server 6 receives the reply from the customer 2 selecting an expert 4, the PPA server 6 places a telephone call to the customer 2 and to the expert 4 and bridges 76 the two parties. Neither the expert nor the customer has access to the other party's phone number. Voice over Internet Protocol (VoIP) can also be used to place the calls using the Internet backbone. When the IP backbone is used, the system uses IP multicasting to quickly and efficiently reach the experts. When the PPA server 6 determines 78 that the conversation has ended, the accounts of the customer 2 and the expert 4 are appropriately charged 80.

The process described above occurs during one “communication session.” In other words, the series of interactions occurring from the time a customer 2 sends a question to receiving help from an expert 4 are completed during one communication session. A “communication session” comprises a continuous series of interactions, all of which are completed within a relatively short period of time without significant delays occurring between the interactions. A communication session is completed within a matter of minutes, and enables a customer 2 to receive help from an expert 4 in real-time. In contrast, in e-mail communications, for example, significant delays can result from the time a person sends a message to the time the person receives a reply message.

Prepaid billing is used in the preferred embodiment of the present invention. A service provider incurs the cost of placing the phone calls to the customer 2 and the expert 4. The customer 2 pays a premium over the charge rate of the expert 4 for the service. This premium covers the cost of the phone calls and some profit for the service provider. The expert 4 also pays a percentage of his or her charge to the service provider for using the platform. A telecommunications service provider may purchase such a platform from a telecommunications equipment provider and choose to be the operator of such a service, (e.g., as an extension of the telecommunications service provider's customer service center). Alternatively, a third-party operator may also provide the service.

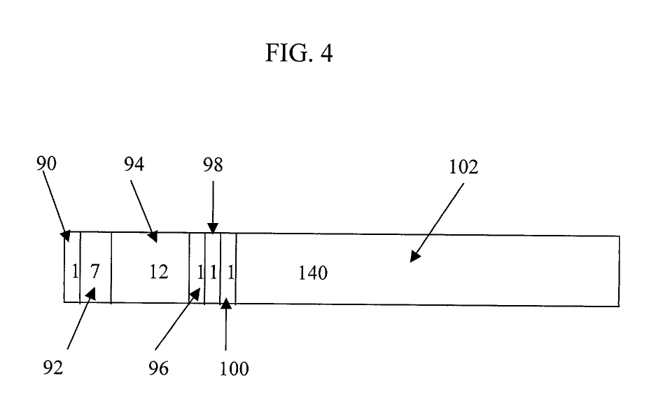

FIG. 4 illustrates an example of the structure of the SMS message initially sent from the customer 2 to the PPA server 6, which contains the customer's question. The header field (1 byte) 90 identifies the type of message. Examples of types of messages include the following: deliver (mobile-terminated only), submit (mobile-originated only), cancellation (mobile-originated only), delivery acknowledgement (mobile-terminated only), and user acknowledgement (either direction).

The service center time stamp field (7 bytes) 92 has the format YYMMDDHHMMSSZZ, where YYMMDD is the year, month, and day; HHMMSS is the hour, minutes, and seconds; and ZZ is the time zone. The next 12 bytes of the SMS message contain the originator address 94.

The next three bytes of the SMS message include the protocol identifier field 96, the data coding scheme field 98, and the user data length field 100. The protocol identifier field 96 parameter includes one octet. Examples of protocol information identified by the protocol identifier field 96 include the following: telex (or teletex reduced to telex format), group 3 telefax, group 4 telefax, voice telephone (i.e., conversion to speech), the European Radio Messaging System (ERMES), and the National Paging System (known to the Supplemental Communications Authority (SC)). The data coding scheme field 98 contains information about whether the text is compressed or uncompressed, which alphabet is being used (default, 8-bit, Unicode Standard UCS2 (16 bit)), and message class (mobile equipment (ME) specific, subscriber identity module (SIM) specific, or terminal equipment (TE) specific).

The customer's question is contained within the user data field 102 (up to 140 bytes), which is coded according to the data coding scheme field 98.

After the PPA server 6 receives the SMS message from the customer 2, it removes the service center time stamp field 92 and the originator address field 94 by copying the contents of the user data field 102 to a new SMS message. This new SMS message is then sent to the experts 4. The SMS center 30 (FIG. 1) perceives the message as originating at the PPA server 6 within the PPA service center, and places the PPA service center time zone in the service center time stamp field 92 and the address of the PPA service center in the originator address field 94. Thus, the customer-related contact information is shielded from the experts 4, while preserving the authenticity of the “free format” question.

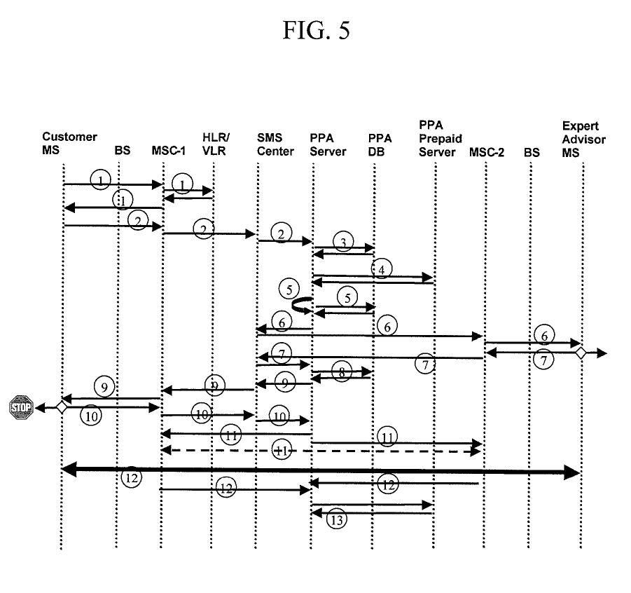

FIG. 5 is a call flow diagram of the flow of data during the operation of the preferred embodiment of the present invention. Each operation is designated with a number in a circle and the numbers correspond to the description below. In FIG. 5, prepaid billing is used, the customer 2 mobile station (MS) is controlled by MSC-1, and the expert 4 mobile station is controlled by MSC-2.

At operation 1, the customer 2 uses a wireless phone and the cellular/PCS network to register with the PPA server 6. Data flows between the customer MS, the customer's base station (BS), and MSC-1, using a home location register/visitors' location register (HLR/VLR) to identify/verify a subscriber.

At operation 2, the customer 2 sends a question as an SMS message to the PPA server 6. Data flows between the customer MS, the customer's base station, MSC-1, the SMS center 30, and the PPA server 6.

At operation 3, the PPA server 6 queries the PPA database 8 to determine whether the customer 2 is registered for the PPA service.

At operation 4, the PPA server 6 queries the prepaid server 20 to determine whether the customer 2 has sufficient resources in his or her account.

At operation 5, the PPA server 6 performs text indexing on the SMS message received from the customer 2 to find keywords. The PPA server 6 performs keyword matching with the expert advisor information in the PPA database 8. Based on the percentage of keywords matched, the PPA server 6 determines one or more experts 4 who may be willing to answer the customer's question.

At operation 6, after processing the SMS message from the customer 2, the PPA server 6 forwards the question to the experts 4 identified in step 5 in another SMS message. Data flows between the PPA server 6, the SMS center 30, the MSC-2, the expert's base station, and the expert advisor MS.

At operation 7, the experts 4 who read the question and are willing to answer it press an “accept” or reply button on their phones, sending another SMS message back to the PPA server 6 and informing the PPA server 6 which experts 4 want to respond to the question. Data flows between the expert advisor MS, the expert's base station, the MSC-2, the SMS center 30, and the PPA server 6.

At operation 8, for the experts 4 who are willing to answer the question but did not provide charge rate information in their messages accepting the question, the PPA server 6 queries the PPA database 8 to get the charging rate information from the expert advisor profile 10.

At operation 9, the PPA server 6 sends an SMS message to the customer 2, informing the customer 2 that one or more experts 4 are willing to answer the question. This SMS message contains expert charge rate information and additional information such as customer satisfaction. Data flows between the PPA server 6, the SMS center 30, the MSC-1, the customer's base station, and the customer MS.

If the customer does not respond, then processing ends. Otherwise, at operation 10, the customer 2 selects an expert 4 and replies to the message from the PPA server 6, sending an SMS message to the PPA server 6. Data flows between the customer MS, the customer's base station, the MSC-1, the SMS center 30, and the PPA server 6.

At operation 11, the PPA server 6 places a phone call to the customer 2 and to the expert 4 who will answer the customer's question and bridges the two parties. Data flows between the PPA server 6, the MSC-1, and the MSC-2.

At operation 12, a phone conversation takes place between the customer 2 and the expert 4. Data flows between the customer MS, the customer's base station, the MSC-1, the PPA server 6, the MSC-2, the expert's base station, and the expert advisor MS.

At operation 13, upon completion of the conversation, the PPA server 6 queries the prepaid server 20 to make adjustments to the expert 4 and the customer 2 accounts.

In another embodiment of the present invention, the customers 2 and experts 4 may still communicate with one another even if some of the customers 2 or experts 4 do not have SMS-enabled phones. In this embodiment, a customer 2 places a phone call to the PPA server 6 and speaks his or her question. A conventional voice engine 22 (FIG. 1) recognizes the keywords and performs audio keyword indexing for cross-referencing. To increase the accuracy of audio keyword indexing, the voice engine 22 can provide a menu of keyword categories (e.g., computer software, operating systems, Windows NT®, etc.) from which the customer 2 chooses before reading his or her question. The voice engine 22 may use conventional speech recognition technology and text-to-speech (TTS) to play back and verify the keywords. If the experts 4 do not have SMS-enabled phones, then the PPA server 6 places phone calls to the experts 4, uses the TTS technology of the voice engine 22 to read the question, and directs the experts 4 to press a certain key if they are willing to accept the question.

In another embodiment, the present invention is transparent to device capabilities; that is, the present invention can serve a mix of customers 2 and experts 4 with different end-user devices, such as phones without SMS capability, mobile phones with SMS capability, wire line phones with SMS capability, and phones with IP connectivity. In this embodiment, a capability server 24 (FIG. 1) determines the terminal capabilities and, if necessary, a suitable protocol (e.g., H.248 for codec negotiation in VoIP, etc.) for capability negotiation. Thus, the capability server 24 mediates between the end-user devices.

In contrast to conventional systems and methods, the present invention provides the ability to bring together in real-time experts and people needing advice. Once a list of experts is chosen, the present invention uses SMS to push a question from a customer to the experts. This feature allows the present invention to determine in real-time the experts willing to help the customer, and to connect the customer and the expert in real-time. In addition, the question is sent to the experts exactly as written by the customer, without modification or interpretation by another party. In contrast, sending an e-mail message, for example, to an expert and waiting for a response does not provide real-time operations. If an expert is away from his or her computer, then a response may not be received for hours or days. Also, rather than the customer performing his or her own search for an expert, the present invention finds the experts for the customer, saving the customer much time and effort.

Further, the present invention provides the ability to obtain answers to questions wherever cell phone coverage exists. There is no need for IP-capable devices, such as laptop computers, personal computers, or personal digital assistants (PDAs) or access to the Internet.

The present invention also includes permanent or removable storage, such as magnetic and optical discs, RAM, ROM, etc., on which the process and data structures of the present invention can be stored and distributed. The processes can also be distributed via, for example, downloading over a network such as the Internet.

The many features and advantages of the invention are apparent from the detailed specification and, thus, it is intended by the appended claims to cover all such features and advantages of the invention which fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, failing within the scope of the invention.

What is claimed is:

1. A system for real-time connection of a customer and an expert, comprising:
a database storing information about registered customers and experts, the information comprising keywords provided by the experts during registration; and
a server, during a communication session, receiving a question from one of the customers, sending the question to experts determined by matching keywords in the question with the keywords in the database, and establishing a connection between the customer and an expert selected by the customer from experts wanting to answer the question.

2. The system of claim 1, wherein the customer and the experts communicate with the server using short messaging service messages.

3. The system of claim 1, wherein the customer and the experts communicate with the server using wireless phones.

4. The system of claim 1, wherein the customer and the experts communicate with the server using Voice over Internet Protocol (VoIP).

5. The system of claim 4, wherein the server communicates with the experts using IP multicasting.

6. The system of claim 1, further comprising a voice engine for providing voice communications between the customer and the server and between the experts and the server.

7. The system of claim 1, further comprising:
a first communication device used by the customer;
a second communication device used by an expert; and
a capability server for mediating between the first communication device and the second communication device when the first communication device and the second communication device have different communication capabilities.

8. The system of claim 1, further comprising:
a communication device without short messaging service capabilities, wherein the customer speaks the question into the communication device; and
a voice engine recognizing keywords from the spoken question.

9. The system of claim 1, further comprising:
a communication device without short messaging service capabilities used by an expert; and
a voice engine reading the question to the expert.

10. The system of claim 1, further comprising a prepaid server charging accounts of the customer and the selected expert after the connection is disconnected and a conversation between the customer and the selected expert ends.

11. The system of claim 1, wherein the information stored about customers comprises name, account number, a phone number of an short messaging service-enabled mobile phone, address, and a preferred language.

12. The system of claim 1, wherein the information stored about experts further comprises name, account number, a phone number of an short messaging service-enabled mobile phone, address, languages spoken, expertise area, and charge rate.

13. The system of claim 12, wherein the information stored about the experts further comprises ratings of experts.

14. The system of claim 1, wherein the keywords in the question are determined by the server performing text indexing on the question, and the keywords in the question are used by the server to query the database to perform keyword matching between the keywords in the question and the keywords provided by the experts during registration.

15. The system of claim 1, wherein the experts wanting to answer the question are provided to the customer based on the percentage of the keywords matched.

16. The system of claim 1, wherein the server removes information from the question sent to the experts that would identify the customer.

17. An advisory method, comprising:
receiving a question from a registered customer during a communication session;
sending the question to a plurality of registered experts during the communication session, the experts receiving the question determined by matching keywords in the question with keywords provided by the experts during registration; and
establishing a connection during the communication session between the customer and an expert selected by the customer from experts wanting to answer the question.

18. The method of claim 17, further comprising charging accounts of the customer and the selected expert after the connection is disconnected and a conversation between the customer and the selected expert ends.

19. The method of claim 17, further comprising performing text indexing on the question to determine the keywords in the question, and using, by the server, the keywords in the question to query the database to perform keyword matching between the keywords in the question and the keywords provided by the experts during registration.

20. The method of claim 17, further comprising mediating between a first communication device used by the customer and a second communication device used by an expert when the first communication device and the second communication device have different communication capabilities.

21. The method of claim 17, further comprising recognizing keywords from a question spoken into a communication device without short messaging service capabilities.

22. The method of claim 17, further comprising reading the question to an expert when a communication device used by the expert is without short messaging service capabilities.

23. A computer-readable storage controlling a computer and comprising a process of:
receiving a question from a registered customer during a communication session;
sending the question to a plurality of registered experts during the communication session, the experts receiving the question determined by matching keywords in the question with keywords provided by the experts during registration; and
establishing a connection during the communication session between the customer and an expert selected by the customer from experts wanting to answer the question.

24. An advisory method, comprising:
registering a plurality of customers and a plurality of experts, the experts providing keywords;
starting a communication session by receiving a question as an short messaging service message from one of the customers;
extracting keywords from the question;
matching the keywords from the question and the keywords provided by the experts to generate a list of one or more experts to receive the question;
sending the question as another short messaging service message to the experts on the list of experts;
receiving responses from experts on the list of experts wanting to answer the question;
informing the customer sending the question of the experts wanting to answer the question;
establishing a connection between the customer sending the question and an expert selected by the customer from the experts wanting to answer the question, the connection comprising a telephone call to the selected expert bridged to a telephone call to the customer; and
ending the communication session when the connection is disconnected.

25. A method, comprising:
selecting an expert based on a question submitted by a customer; and
connecting, directly, the expert and the customer via a telephone call.

26. The method of claim 25, wherein the question is submitted by short messaging service.

27. The method of claim 25, wherein the question is submitted to the expert without identifying the customer.

28. The method of claim 27, wherein the expert responds to the question with a short messaging service message accepting responsibility for answering the question.

29. The method of claim 25, wherein the connecting comprises a telephone call to the expert bridged to a telephone call to the customer.

30. The method of claim 25, wherein the selecting comprises:
determining a word index math between the question and keywords describing expertise of more than one expert; and
designating the expert with a highest percentage match.

31. The method of claim 25, wherein the selecting comprises:
determining a word index match between the question and keywords describing expertise of several experts; and
providing the customer with a list of the experts with a highest percentage match.

32. The method of claim 25, wherein the selecting and connecting are within a single communication session.
